(19) United States
(12) Patent Application Publication
(10) Pub. No.: US 2026/0303211 A1
(43) Pub. Date: Oct. 1, 2026

(54) WIRELESS COMMUNICATION SYSTEM, CONTROL APPARATUS, AND CONTROLMETHOD

(71) Applicant: NTT, Inc., Tokyo (JP)

(72) Inventors: Toshiro NAKAHIRA, Tokyo (JP); Ryota SHIINA, Tokyo (JP); Tatsuhiko IWAKUNI, Tokyo (JP); Takuto ARAI, Tokyo (JP)

(73) Assignee: NTT, Inc., Tokyo (JP)

(21) Appl. No.: 18/993,073

(22) PCT Filed: Jul. 11, 2022
(86) PCT No.: PCT/JP2022/027287

§ 371 Date: Jan. 10, 2025

(51) Int. Cl. H04B 10/079; H04B 10/11

(52) U.S. Cl. CPC H04B 10/07953; H04B 10/11

(57) ABSTRACT

A wireless communication system which includes a terminal and a base station which transmit and receive signals to each other through optical wireless communication and a control device which controls the base station. The control device includes: an information acquisition part which acquires information indicating communication quality from the base station; and a shielding detection part which detects shielding which affects optical wireless communication between the base station and the terminal or another device on the basis of information indicating the communication quality.

### TECHNICAL FIELD

The present invention relates to a wireless communication system, a control device, and a control method.

### BACKGROUND ART

Wireless sensing methods which collect and analyze information sensed using wireless communication devices are being considered for various applications. For example, NPL 1 discloses a wireless sensing method for detecting an object using machine learning. Furthermore, NPL 2 discloses a wireless sensing method for detecting a bird and an animal by analyzing fluctuations in wireless LAN radio waves.

### CITATION LIST

### Non Patent Literature

[NPL 1] NTT Access Service Systems Laboratories, “Object Detection Technique based on Wireless LAN Channel Information using Machine Learning”, https://www.rd.ntt/as/history/wireless/wi0517.html
[NPL 2] NTT Technology Journal, “Bird and Beast Detection System using Wireless LAN Radio Waves”, https://journal.ntt.co.jp/article/4556

### SUMMARY OF INVENTION

### Technical Problem

In the related art, wireless sensing using infrared rays, camera images, or the like requires the installation of a dedicated device for sensing which poses the problem of making it difficult to simplify a facility.

An object of the disclosed technique is to facilitate simplification of a facility for wireless sensing.

### Solution to Problem

The disclosed technique is a wireless communication system which includes a terminal and a base station which transmit and receive signals to each other through optical wireless communication and a control device which controls the base station, in which the control device includes: an information acquisition part which acquires information indicating communication quality from the base station; and a shielding detection part which detects shielding which affects optical wireless communication between the base station and the terminal or another device on the basis of information indicating the communication quality.

### Advantageous Effects of Invention

It is possible to simplify a facility for wireless sensing.

### BRIEF DESCRIPTION OF DRAWINGS

FIG. 1 is a diagram showing an example of a configuration of a wireless communication system according to Example 1 of an embodiment of the present invention.

FIG. 2 is a diagram showing an example of a functional configuration of a control device according to Example 1 of the embodiment of the present invention.

FIG. 3 is a diagram showing an example of a functional configuration of a base station according to Example 1 of the embodiment of the present invention.

FIG. 4 is a flowchart for describing an example of a flow of detection processing according to Example 1 of the embodiment of the present invention.

FIG. 5 is a diagram showing an example of a configuration of a wireless communication system according to Example 2 of the embodiment of the present invention.

FIG. 6 is a diagram showing an example of a functional configuration of a control device according to Example 2 of the embodiment of the present invention.

FIG. 7 is a flowchart for describing an example of a flow of detection processing according to Example 2 of the embodiment of the present invention.

FIG. 8 is a diagram showing an example of a hardware configuration of a computer.

### DESCRIPTION OF EMBODIMENTS

An embodiment of the present invention (an embodiment) will be described below with reference to the drawings. The embodiment which will be described below are merely an example and embodiments to which the present invention is applied are not limited to the following embodiment.

### Overview of Embodiment

In an embodiment, an example in which a wireless device for optical wireless communication is used for sensing purposes will be described.

Examples 1 and 2 will be described below as specific examples of the embodiment.

### Example 1

In the embodiment, an example in which a visible light type optical wireless communication device is used for sensing purposes will be described.

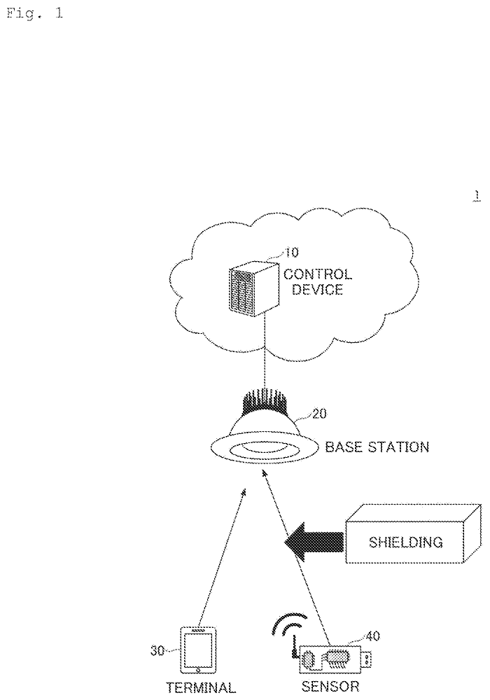

FIG. 1 is a diagram showing an example of a configuration of a wireless communication system according to Example 1 of an embodiment of the present invention. A wireless communication system 1 includes a control device 10, a base station 20, a terminal 30, and a sensor 40.

The control device 10 is a device which controls optical wireless communication between the base station 20 and the terminal 30, the sensor 40, and the like. The control device 10 is communicably connected to the base station 20 via a wired or wireless communication line. The control device 10 acquires information indicating the quality of optical wireless communication from the base station 20 and detects the presence or absence of shielding which affects the optical wireless communication between the base station 20 and the terminal 30, the sensor 40, and the like.

The base station 20 is a device which performs visible light optical wireless communication with a terminal 30, a sensor 40, and the like. The base station 20 estimates the quality of optical wireless communication with the terminal 30, the sensor 40, and the like and transmits information indicating the quality of optical wireless communication to the control device 10 on the basis of the estimation result. Furthermore, the base station 20 transmits information indicating the position, the direction, or the like of the terminal 30 to the control device 10.

The terminal 30 is a device which is used by a user and functions as a mobile station which moves with the user. The communication state between the terminal 30 and the base station 20 changes depending on the position, the direction, or the like of the terminal 30.

The sensor 40 is installed at a fixed location and periodically transmits detected information to the base station 20, for example, via optical wireless communication.

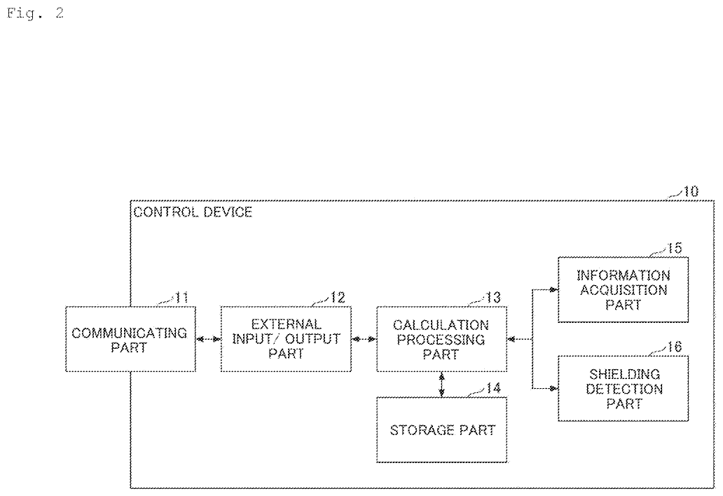

FIG. 2 is a diagram showing an example of a functional configuration of a control device according to Example 1 of the embodiment of the present invention. The control device 10 includes a communication part 11, an external input/output part 12, a calculation processing part 13, a storage part 14, an information acquisition part 15, and a shielding detection part 16.

The communication part 11 transmits and receives information to and from the base station 20. Specifically, the communication part 11 receives information indicating the quality of optical wireless communication and information indicating the position, the direction, or the like of the terminal 30 from the base station 20. Furthermore, the communication part 11 may transmit information indicating the shielding detected by the shielding detection part 16 to the base station 20.

The external input/output part 12 inputs data necessary for the calculation performed by the calculation processing part 13 to the calculation processing part 13 or outputs data as a result of the calculation performed by the calculation processing part 13. Specifically, the external input/output part 12 inputs the information received by the communication part 11 to the calculation processing part 13. Furthermore, the external input/output part 12 may output information indicating the shielding detected by the shielding detection part 16.

The calculation processing part 13 performs calculations based on the input data. Specifically, the calculation processing part 13 performs calculations based on information indicating the quality of optical wireless communication and information indicating the position, the direction, or the like of the terminal 30 and calculates a value for determining the presence or absence of shielding.

The storage part 14 stores data necessary for calculation. Specifically, the storage part 14 stores information indicating the quality of optical wireless communication, information indicating shielding detected by the shielding detection part 16, and the like.

The information acquisition part 15 acquires information indicating the quality of optical wireless communication and information indicating the position, the direction, or the like of the terminal 30 from the base station 20 via the communication part 11, the external input/output part 12, and the like.

The shielding detection part 16 detects shielding between the base station 20 and the terminal 30 or the sensor 40. Specifically, the shielding detection part 16 determines the presence or absence of shielding on the basis of the calculation results using the calculation processing part 13 regarding information indicating the quality of optical wireless communication and information indicating the position, the direction, or the like of the terminal 30.

For example, with regard to the communication between the base station 20 and the sensor 40, the shielding detection part 16 may determine that there is shielding when the quality of the optical wireless communication deteriorates on the basis of information indicating the quality of the optical wireless communication. Furthermore, with regard to the communication between the base station 20 and the terminal 30, the shielding detection part 16 may determine that there is shielding when the quality of optical wireless communication is lower than the quality estimated from the position, the direction, or the like of the terminal 30 on the basis of information indicating the quality of optical wireless communication and information indicating the location, the direction, or the like of the terminal 30.

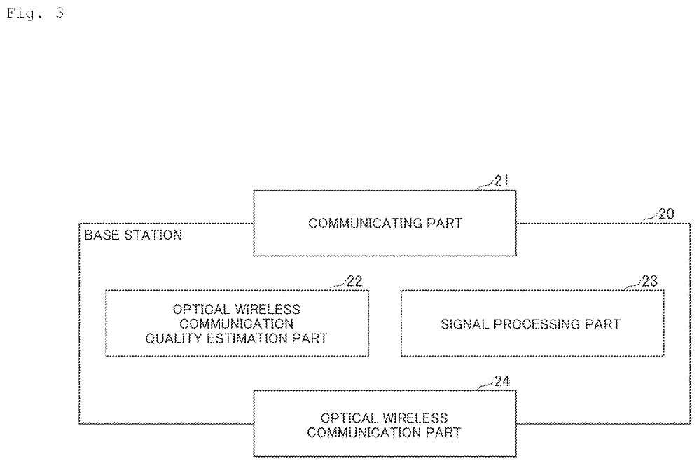

FIG. 3 is a diagram showing an example of a functional configuration of a base station according to Example 1 of the embodiment of the present invention. The base station 20 includes a communication part 21, an optical wireless communication quality estimation part 22, a signal processing part 23, and an optical wireless communication part 24.

The communication part 21 transmits and receives information to and from the control device 10. Specifically, the communication part 21 transmits information indicating the quality of optical wireless communication and information indicating the position, the direction, or the like of the terminal 30 to the control device 10. Furthermore, the communication part 21 may receive information indicating the shielding detected by the shielding detection part 16 from the control device 10.

The optical wireless communication quality estimation part 22 estimates the quality of optical wireless communication with the terminal 30 or the sensor 40 and transmits information indicating the estimated quality of optical wireless communication to the control device 10 via the communication part 21. For example, the optical wireless communication quality estimation part 22 may estimate the communication quality on the basis of a change in the communication state such as the failure of regularly transmitted and received data or the occurrence of a packet error.

The signal processing part 23 processes signals transmitted and received in optical wireless communication with the terminal 30 or the sensor 40.

The optical wireless communication part 24 performs optical wireless communication with the terminal 30 or the sensor 40.

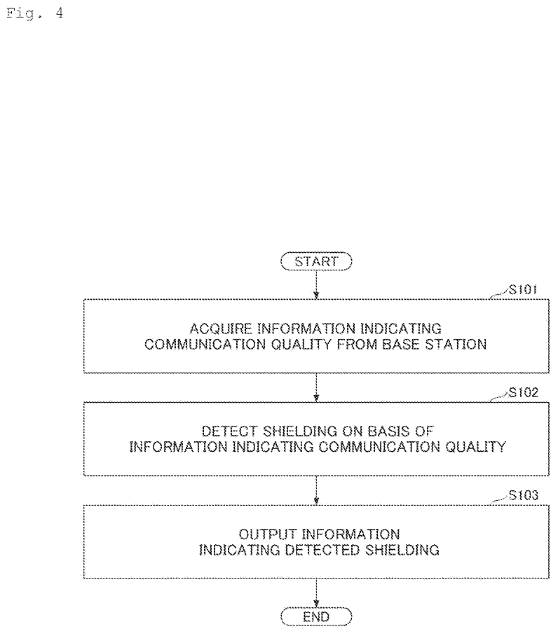

FIG. 4 is a flowchart for describing an example of a flow of detection processing according to Example 1 of the embodiment of the present invention. The control device 10 performs the detection process periodically or in response to a user's operation.

The information acquisition part 15 acquires information indicating communication quality from the base station 20 (Step S101). Here, the information acquisition part 15 may acquire information indicating the position, the direction, or the like of the terminal 30.

The shielding detection part 16 detects shielding on the basis of information indicating communication quality (Step S102). Specifically, the shielding detection part 16 detects shielding between the base station 20 and the sensor 40 when the communication quality has deteriorated. Furthermore, the shielding detection part 16 may detect shielding between the terminal 30 and the base station 20 on the basis of information indicating communication quality and information indicating the position, the direction, or the like of the terminal 30. In this case, the shielding detection part 16 may determine that there is shielding when the quality of optical wireless communication is lower than the quality estimated from the position, the direction, or the like of the terminal 30.

Subsequently, the communication part 11 outputs information indicating the detected shielding to the base station 20 (Step S103). The base station 20 may schedule optical wireless communication on the basis of the received information indicating shielding.

According to this embodiment, the control device 10 detects shielding on the basis of information indicating communication quality. Thus, since there is no need to add a dedicated facility for wireless sensing, the facility can be easily simplified and the facility costs can be prevented from increasing.

### Example 2

Example 2 will be described below with reference to the drawings. Example 2 differs from Example 1 in that a heat source is detected in infrared optical wireless communication. Therefore, in the description of Example 2 which will be described below, the explanation will focus on the differences from Example 1 and the same functional configurations as in Example 1 will be denoted by the same reference numerals as those used in the explanation of Example 1 and the explanation thereof will be omitted.

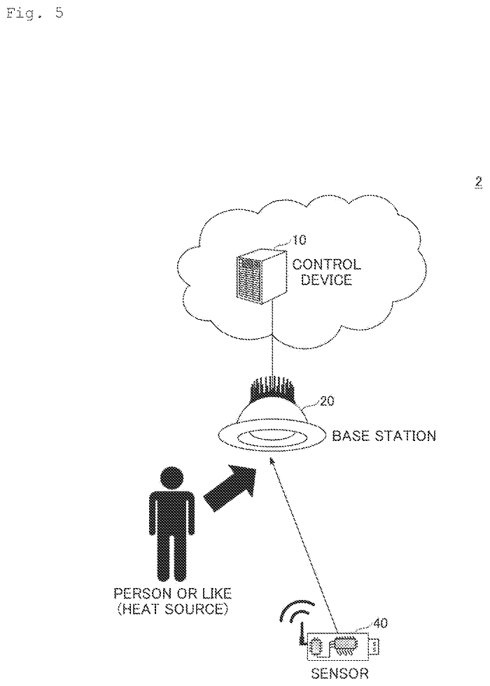

FIG. 5 is a diagram showing an example of the configuration of a wireless communication system according to Example 2 of the embodiment of the present invention. A wireless communication system 2 according to the embodiment includes a control device 10, a base station 20, and a sensor 40. The base station 20 according to the example communicates with the sensor 40 using infrared optical wireless communication.

In addition to the shielding detection according to Example 1, the wireless communication system 2 according to the example detects the presence of a heat source by detecting infrared rays emitted by a heat source such as a person as noise.

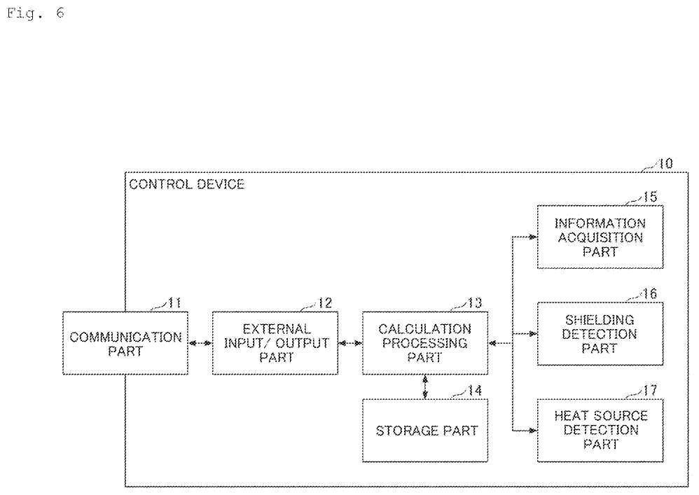

FIG. 6 is a diagram showing an example of a functional configuration of a control device according to Example 2 of the embodiment of the present invention. The control device 10 according to the example has a configuration in which a heat source detection part 17 is added to the control device 10 according to Example 1.

Furthermore, the information acquisition part 15 according to the example acquires, from the base station 20, as information indicating the communication quality, for example, information indicating the signal-to-noise (SN) ratio of signals to be transmitted and received.

The heat source detection part 17 detects a heat source on the basis of information indicating communication quality (for example, SN ratio). Specifically, if the heat source detection part 17 determines that the noise floor has increased due to a decrease in the SN ratio, or the like, it may determine that the heat source has approached.

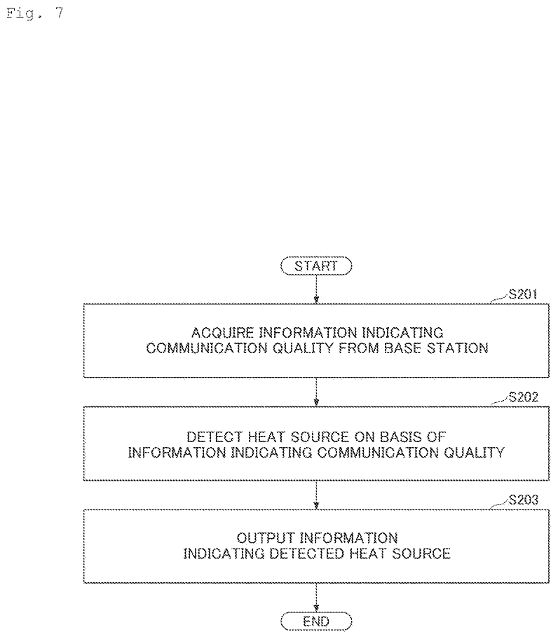

FIG. 7 is a flowchart for describing an example of the flow of detection processing according to Example 2 of the embodiment of the present invention. In the detection process according to the example, the information acquisition part 15 acquires information indicating communication quality from the base station 20 (Step S201). Here, the information acquisition part 15 may acquire information indicating the SN ratio of signals transmitted and received by the base station 20.

The heat source detection part 17 detects a heat source on the basis of information indicating communication quality (Step S202). Specifically, the heat source detection part 17 detects the heat source near base station 20 or the sensor 40 when communication quality (for example, SN ratio) has decreased.

Subsequently, the communication part 11 outputs information indicating the detected heat source to the base station 20 (Step S203). The base station 20 may schedule optical. wireless communication on the basis of the received information indicating the heat source.

According to the example, the control device 10 detects a heat source on the basis of information indicating communication quality. Thus, since there is no need to add a dedicated device for detecting the heat source, it is possible to simplify the facility and prevent an increase in facility costs.

Although a method for realizing wireless sensing at the optical wireless communication base station 20 has been described in each of the examples described above, wireless sensing at the terminal 30 may also be realized. For example, the control device 10 may acquire information indicating communication quality from the terminal 30 and detect shielding or a heat source based on the information.

Furthermore, the control device 10 may perform information analysis using a combination of other wireless communication methods in addition to wireless devices using the optical wireless communication method. For example, the control device 10 may further estimate the communication quality using wireless LAN for a terminal determined to be shielded by optical wireless communication and estimate the degree of shielding.

Furthermore, although wireless sensing between a pair of the optical wireless communication base station 20 and terminal 30 has been described in each of the above-mentioned embodiments, wireless sensing between the base station 20 and a plurality of terminals 30 may be used or information collected from a plurality of base stations 20 may be analyzed in an integrated manner by the control device 10. For example, the magnitude of shielding for each base station 20 may be estimated by acquiring Information indicating not only a communication pair between a certain base station 20 and a terminal 30 but also a communication quality between a base station 20 and a terminal 30 adjacent to the base station 20.

Furthermore, although explanations have been provided assuming a single wireless communication method in each of the above-described examples, the base station 20 may have a function of switching wireless communication methods or using them in combination as necessary. In that case, the base station 20 may switch to a wireless communication method suitable for wireless sensing to improve the accuracy of wireless sensing. For example, when a plurality of frequency bands can be selected, the base station 20 may select a communication method using infrared rays to detect the influence of thermal noise. Here, if a plurality of base stations 20 use the same frequency band, interference between the base stations 20 becomes an issue. Thus, it is possible to periodically sense a heat source while avoiding interference between base stations 20, for example, by using infrared light between a plurality of base stations 20 sequentially and using visible light for other base stations 20.

### <Hardware Configuration>

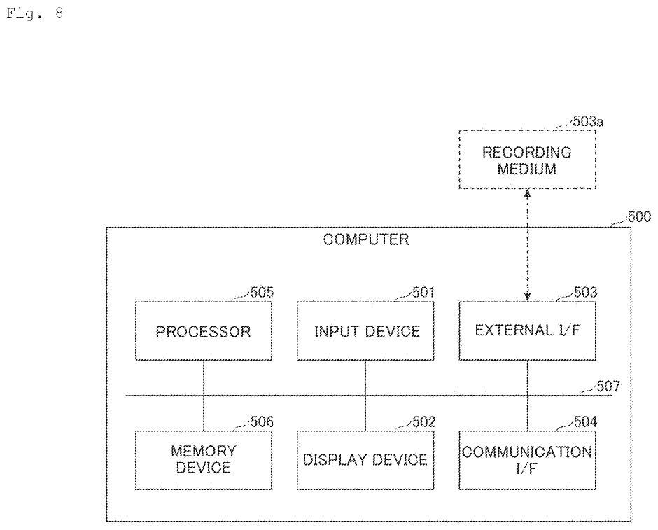

Finally, a hardware configuration of the control device 10, the base station 20, or the terminal 30 according to the embodiment will be explained. The control device 10, the base station 20, or the terminal 30 according to the embodiment is realized by, for example, the hardware configuration of a computer 500 shown in FIG. 8.

A computer 500 shown in FIG. 8 includes an input device 501, a display device 502, an external I/F 503, a communication I/F 504, a processor 505, and a memory device 506. Each of these pieces of hardware is communicably connected via a bus 507.

The input device 501 is, for example, a keyboard, a mouse, a touch panel, or the like. The display device 502 is, for example, a display. Note that the computer 500 does not need to include at least one of the input device 501 and the display device 502.

The external I/F 503 is an interface with external devices such as a recording medium 503a. Note that examples of the recording medium 503a include a compact disc (CD), a digital versatile disk (DVD), a secure digital (SD) memory card, and a universal serial bus (USB) memory card.

The communication I/F 504 is an interface through which data communication with other devices, devices, systems, and the like is performed. The processor 505 is, for example, various calculation devices such as a CPU. The memory device 506 is, for example, various storage devices such as an HDD, an SSD, a random access memory (RAM), a read only memory (ROM), and a flash memory.

The control device 10, the base station 20, or the terminal 30 according to the embodiment can implement the various processes described above by having the hardware configuration of the computer 500 shown in FIG. 8. Note that the hardware configuration of the computer 500 shown in FIG. 8 is an example and the computer 500 may have other hardware configurations. For example, the computer 500 may have a plurality of processors 505 and a plurality of memory devices 506.

The control device 10, the base station 20, or the terminal 30 according to the embodiment is realized by reading a program causing the computer 500 to execute each of the above-described processes and performing the processes specified in the program. The program may be recorded on the recording medium 503a or the like or may be provided through a network.

### Summary of Embodiment

This specification describes at least the wireless communication system, the control device, and the control method described in the following items.

### Item 1

A wireless communication system which includes a terminal and a base station which transmit and receive signals to each other through optical wireless communication and a control device which controls the base station,
wherein the control device includes
an information acquisition part which acquires information indicating communication quality from the base station; and a shielding detection part which detects shielding which affects optical wireless communication between the base station and the terminal or another device on the basis of information indicating the communication quality.

### Item 2

The wireless communication system according to Item 1, wherein the information acquisition part further acquires information indicating a position or a direction of the terminal, and the shielding detection part detects shielding which affects optical wireless communication between the base station and the terminal on the basis of information indicating the communication quality and information indicating the position or the direction of the terminal.

### Item 3

The wireless communication system according to Item 2, the control device further including
a heat source detection part which detects a heat source which affects optical wireless communication between the base station and the terminal or another device on the basis of information indicating the communication quality.

### Item 4

A control device for controlling a base station which transmits and receives signals to and from terminals through optical wireless communication, including:
an information acquisition part which acquires information indicating communication quality from the base station; and
a shielding detection part which detects shielding which affects optical wireless communication between the base station and the terminal or another device on the basis of information indicating the communication quality.

### Item 5

A control method performed by a control device for controlling a base station which transmits and receives signals to and from a terminal through optical wireless communication, including:
a step of acquiring information indicating communication quality from the base station; and
a step of detecting shielding which affects optical wireless communication between the base station and the terminal or another device on the basis of information indicating the communication quality.

Although the embodiment has been described above, the present invention is not limited to such specific embodiment and various modifications and changes can be provided within the scope of the gist of the present invention as described in the claims.

### REFERENCE SIGNS LIST

1 Wireless communication system
10 Control device
11 Communicating part
1.2 External input/output part
13 Calculation processing part
14 Storage part
1.5 Information acquisition part
16 Shielding detection part
17 Heat source detection part
20 Base station
21 Communication part
22 Optical and wireless communication quality estimation part
23 Signal processing part
24 Optical wireless communication part
30 Terminal
40 Sensor
500 Computer
501 Input device
502 Display device
503 External I/F
503a Recording medium
504 Communication I/F
505 Processor
506 Memory device
507 Bus

1. A wireless communication system comprising:
a terminal and a base station configured to transmit and receive signals to each other through optical wireless communication; and
a control device which controls the base station, the control device comprising:
an information acquisition part configured to acquire information indicating a communication quality from the base station; and
a shielding detection part configured to detect shielding which affects the optical wireless communication between the base station and the terminal or another device based on the information indicating the communication quality.

2. The wireless communication system according to claim 1, wherein the information acquisition part is configured to acquire information indicating a position or a direction of the terminal, and
the shielding detected by the shielding detection part affects the optical wireless communication between the base station and the terminal, and the shielding detection part detects the shielding based on the information indicating the communication quality and the information indicating the position or the direction of the terminal.

3. The wireless communication system according to claim 2, wherein the control device further includes
a heat source detection part configured to detect a heat source which affects the optical wireless communication between the base station and the terminal or the another device based on the information indicating the communication quality.

4. A control device for controlling a base station which transmits and receives signals to and from a terminal through optical wireless communication, the control device comprising:
an information acquisition part configured to acquire information indicating communication quality from the base station; and
a shielding detection part configured to detect shielding which affects the optical wireless communication between the base station and the terminal or another device based on the information indicating the communication quality.

5. A method for controlling a base station which transmits and receives signals to and from a terminal through optical wireless communication, the method comprising:
acquiring, by a control device, information indicating communication quality from the base station; and
detecting, by the control device, shielding which affects the optical wireless communication between the base station and the terminal or another device based on the information indicating the communication quality.

6. A computer-readable memory device storing computer-executable program instructions that, when executed by a processor, cause a computer to execute the method according to claim 5.

7. The wireless communication system according to claim 1, wherein the shielding detection part is configured to determine that the shielding is present between the base station and the another device in response to determining, based on the information indicating the communication quality, that the communication quality of the optical wireless communication between the base station and the another device has deteriorated.

8. The wireless communication system according to claim 2, wherein the shielding detection part is configured to generate, based on the information indicating the position or the direction of the terminal, an estimated communication quality using the position or the direction of the terminal, and determine that the shielding is present between the base station and the terminal when the communication quality is lower than the estimated communication quality.

9. The wireless communication system according to claim 1, wherein the another device is a sensor configured to periodically transmit detected information to the base station via the optical wireless communication.

10. The control device according to claim 4, wherein the information acquisition part is configured to acquire information indicating a position or a direction of the terminal, and
the shielding detected by the shielding detection part affects the optical wireless communication between the base station and the terminal, and the shielding detection part detects the shielding based on the information indicating the communication quality and the information indicating the position or the direction of the terminal.

11. The control device according to claim 10, further comprising:
a heat source detection part configured to detect a heat source which affects the optical wireless communication between the base station and the terminal or the another device based on the information indicating the communication quality.

12. The control device according to claim 4, wherein the shielding detection part is configured to determine that the shielding is present between the base station and the another device in response to determining, based on the information indicating the communication quality, that the communication quality of the optical wireless communication between the base station and the another device has deteriorated.

13. The control device according to claim 10, wherein the shielding detection part is configured to generate, based on the information indicating the position or the direction of the terminal, an estimated communication quality using the position or the direction of the terminal, and determine that the shielding is present between the base station and the terminal when the communication quality is lower than the estimated communication quality.

14. The control device according to claim 4, wherein the another device is a sensor configured to periodically transmit detected information to the base station via the optical wireless communication.

15. The method according to claim 5, further comprising:
acquiring, by the control device, information indicating a position or a direction of the terminal,
wherein the shielding is detected based on the information indicating the communication quality and the information indicating the position or the direction of the terminal.

16. The method according to claim 15, further comprising:
detecting, by the control device based on the information indicating the communication quality, a heat source which affects the optical wireless communication between the base station and the terminal or the another device.

17. The method according to claim 5, further comprising:
determining, based on the information indicating the communication quality, that the communication quality of the optical wireless communication between the base station and the another device has deteriorated, to determine that the shielding is present between the base station and the another device.

18. The method according to claim 15, further comprising:
generating, by the control device based on the information indicating the position or the direction of the terminal, an estimated communication quality using the position or the direction of the terminal; and
determining, by the control device, that the shielding is present between the base station and the terminal when the communication quality is lower than the estimated communication quality.

19. The method according to claim 5, wherein the another device is a sensor configured to periodically transmit detected information to the base station via the optical wireless communication.
